(19) United States
(12) Patent Application Publication
(10) Pub. No.: US 2018/0329700 A1
(43) Pub. Date: Nov. 15, 2018

(54) APPLICATION MIGRATION SYSTEM

(71) Applicant: HEWLETT PACKARD ENTERPRISE DEVELOPMENT LP, HGouston, TX (US)

(72) Inventors: Parag Doshi, Marietta, GA (US); Chandra Kamalakantha, Plano, TX (US); Steven Marney, Lake Orion, MI (US); Michael Reed, Palo Alto, CA (US)

(21) Appl. No.: 15/776,428

(22) PCT Filed: Nov. 30, 2015
(86) PCT No.: PCT/US2015/063026

§ 371 Date: May 16, 2018

(51) Int. Cl. G06F 8/60; G06F 9/455; H04L 12/24; G06F 9/50; G06N 5/04

(52) U.S. Cl. CPC G06F 8/60; G06F 9/45558; H04L 41/12; H04L 67/10; G06F 9/5077; G06N 5/04; H04L 41/5003

(57) ABSTRACT

A target model is determined for a source application that is to be migrated to a target system. The target model can be determined in part from policies and application characteristics of the source application. A deployment plan is determined, based at least in part on the target model, for application functionality that represents a migration of the source application. The deployment plan can include executable instructions to implement multiple deployment objectives of the application functionality with the target system. The instructions of the deployment plan can also include recursive logic to select or configure at least one deployment objective based on an outcome of implementing another deployment objective with the target system.

### BACKGROUND

Because of technological advances, operators or administrators of network computing environments may desire to upgrade and receive benefit of ever advancing computing technologies. Such upgrades can often involve migrating applications and application resources onto new computing environments. More recently, cloud-based computing platforms have emerged that can host or replicate conventional network computing platforms (e.g., enterprises) for user groups of different sizes at significantly lower costs and faster speeds than has been possible ever before. The cloud-based computing platforms offer various benefits, among them high degrees of automation and scalability, wherein the availability of software and hardware resources of network systems can be increased or decreased automatically based on need.

### BRIEF DESCRIPTION OF THE DRAWINGS

FIG. 1 illustrates an example application migration system for migrating application functionality onto a target system.

FIG. 2 illustrates an example method for migrating applications.

FIG. 3 illustrates an example computer system for implementing one or more examples.

### DETAILED DESCRIPTION

Examples include a system and method for migrating application functionality from a source computing environment to a target system. Among other benefits, examples such as described enable migration automation of processes which have previously required man-hours and expertise. Not only do examples reduce man hours and the amount of expertise required to migrate applications, examples further enable an optimized or efficient approach for migrating applications to avoid implementation of processes other than those which are required. A migration of a source application can be performed to account for existing policies which are relevant and affect the use of the source application, as well as constraints or policies which may be desired as a result of characteristics of the target system. Through an optimized or intelligent migration process, application functionality can be established on the target system as a migration of the source application, without waste of computational resources which are typical of rigid conventional approaches.

While the target system can be implemented in many forms, many examples are recited in context of a target system that is cloud-based. By way of example, such cloud-based services offered by HEWLETT PACKARD ENTERPRISE (e.g., HP VIRTUAL PRIVATE CLOUD, HP HELION OPENSTACK, HP HELION EUCALYPTUS, HP PUBLIC CLOUD), AMAZON WEB SERVICES INC. (e.g., AMAZON WEB SERVICES) and MICROSOFT CORPORATION (e.g., AZURE).

In one example, a target model is determined for a source application that is to be migrated to a target system. The target model can be determined in part from application characteristics of the source application. A deployment plan is determined, based at least in part on the target model, for application functionality that represents a migration of the source application. The deployment plan can include executable instructions to implement multiple deployment objectives of the application functionality with the target system. The instructions of the deployment plan can also include recursive logic to select or configure at least one deployment objective based on an outcome of implementing another deployment objective with the target system.

Some examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer programs, or a computer usable carrier medium capable of carrying such a program.

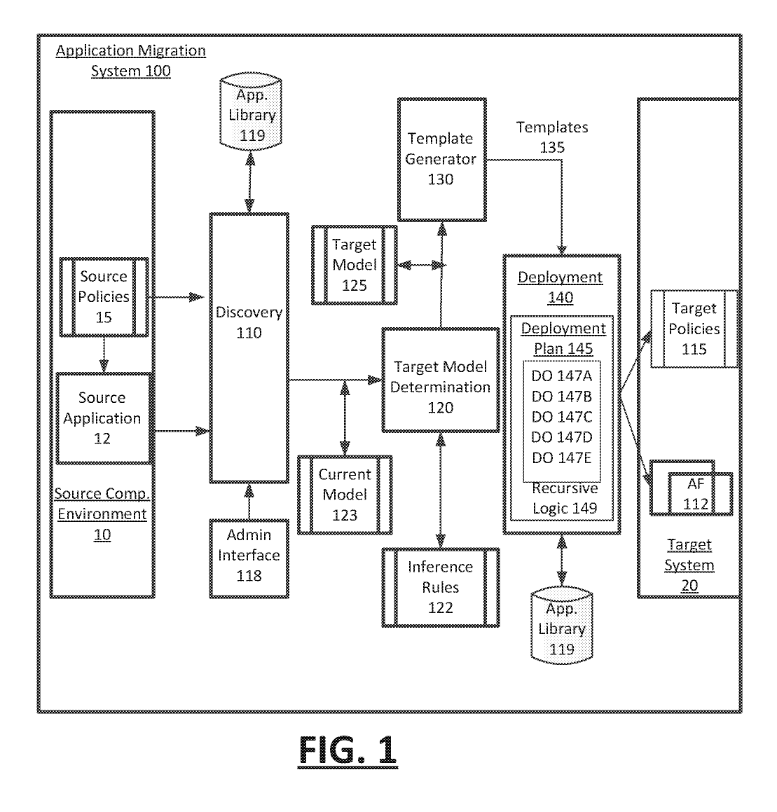

FIG. 1 illustrates an example application migration system for migrating application functionality onto a target system. As described with some examples, a target system 20 can correspond to, for example, an enterprise network or a cloud-based computing platform, and the application functionality that is to be migrated can correlate to or be selected from an application (“source application 12”) of a source computing environment 10.

An example of the application migration system 100 can be implemented in any one of multiple possible computing environments, including, for example, with a stand-alone computer system, as an administrator tool or program for personal or enterprise networks, as a network service, or as an integrated service or aspect of a cloud-based computing platform. Moreover, application migration system 100 can be implemented using components or functionality that is modularized or distributed, depending on implementation. For example, some functional aspects or components of application migration system 100 can be provided as part of the source computing environment 10 from which the source application 12 is selected for migration, while other functional aspects or components of application migration system 100 can reside with the target system 20, or alternatively, with an intermediary service that can be used with the source computing environment 10 or target systems 20.

As described in greater detail, application migration system 100 can provide components or functional aspects to migrate application functionality onto the selected target system 20. In some examples, the selected target system 20 is a cloud-based computing platform, such as provided by variety of vendors (e.g., HP VIRTUAL PRIVATE CLOUD or HP VIRTUAL PUBLIC CLOUD, provided by HEWLETT PACKARD ENTERPRISE INC.). In an example of FIG. 1, the application functionality 112 can represent any one of a program, process, plug-in, application or application platform that is selected for implementation on the target system 20, by way of a correlation to a source application 12 which is selected for migration from the source computing environment 10. The application functionality 112 can, for example, correspond to an alternative but substantially similar instantiation of the source application 12, an alternative version of the source application 12, an equivalent but different application from the source application 12, or a functional component (e.g., plug-in) that can provide sufficiently similar functionality or capability as that provided with the source application 12.

According to some examples, application migration system 100 automates a migration process in which application functionality 112 is selected and provisioned for the target system 20, without rewriting or compiling instruction sets for the target system. In an aspect, application migration system 100 automates a “lift and shift” migration process, in which a programmatic process can automate at least one of (i) evaluation or selection of source application 12 for migration, (ii) evaluation or selection of application functionality 112 on the target system 20, given desired policies and/or service level agreements associated with the source application 12, and (iii) determination and implementation of numerous deployment objectives for the application functionality when provided on the target system 20.

In examples described, “deployment objective” refers to a desired outcome for an aspect of application functionality 112, when established on the target system 20 as a migration of the source application 12. Still further, examples provide that deployment objectives can be linked, categorized, or otherwise associated with tiers or layers that reflect a degree of abstraction with respect to the manner in which the application functionality 112 is deployed on the target system 20. By way of example, the deployment objectives can include higher-level deployment objectives which reflect the manner in which the application functionality 112 is provisioned or contained on the target system 20, mid-level deployment objectives which specify network and/or hardware resources prior to runtime, and lower-level deployment objectives which specify runtime resources that the application functionality 112 utilizes on the target system 20. For example, in a given migration, multiple deployment objectives can be determined, of which at least one deployment objective is determined just-in-time and independent of other deployment objectives (shown as deployment objectives 147A . . . 147E, referred collectively as “deployment objectives 147”). With respect to some examples, an independent or top layer deployment objective 147A can, for example, correspond to provisioning of a container for the application functionality 112. Additionally, for the given migration, multiple deployment objectives can be implemented recursively, so as to be determined and/or implemented after implementation of another deployment objective.

As described in greater detail, deployment objectives for migrating the application functionality 112 onto the target system 20 are implemented using instructions that also implement recursive logic to determine some deployment objectives. For example, some deployment objectives can be determined as dependencies of outcomes for other deployment objectives.

As described in greater detail, in some examples, the application migration system 100 can determine a deployment plan 145 in connection with establishing application functionality 112 as a migration of the source application 12. The deployment plan 145 can incorporate or utilize functionality and definitions provided from multiple templates 135.

In some examples, the templates 135 can be generated automatically based in part on input that includes the target model 125. In some implementations, the templates 135 can include executable instructions, and each template 135 can individually contribute to determinations or specifications of deployment objectives 147. In this respect, the templates 135 can include instructions for implementing corresponding deployment objectives 147, and the deployment plan 145 can include recursive logic to determine and/or implement at least some deployment objectives in a just-in-time manner.

Examples as described with FIG. 1 optimize migration of the source application 12 by enabling just-in time determination and implementation for individual deployment objectives that are dependent on an outcome of implementing another deployment objective for the migration. This represents advancement over some conventional approaches which employ static predetermined deployment topologies which cannot make specific on-the-fly accommodations for deployment objectives that, for example, are not known until another deployment objective is implemented.

Some examples further provide that application migration system 100 enables automation for a decision process that selects the source application(s) 12 (and other applications) from an application library of the source computing environment 10, based on criteria that includes a suitability for migration to the target system 20. The decision process can take into account facets such as source policies 15 of the source computing environment 10, service level agreement considerations, and aspects or characteristics of the target system 20. Still further, as described by examples, the migration process can select and implement application functionality 112 for the target system 20 in a manner that accommodates source policies 15 and/or service level agreements of the source application 12. In contrast to conventional approaches, application migration system 100 can automate a migration process for the source application 12 to reduce computational resources and manpower that would otherwise be needed to perform, for example, a “lift and shift” migration. Additionally, in some examples, application migration system 100 can optimize provisioning, network topology creation, and other configurations which can affect allocation or use of logical or physical resources of the target system 20, while at the same time discovering and adhering to source policies 15 and constraints that are determined from the source computing environment 10 or the administrator.

With further reference to an example of FIG. 1, application migration system 100 includes a discovery component 110, a target model determination component 120, a template generator 130, and a deployment component 140. The discovery component 110 can include functionality to interface with the source computing environment 10 in order to determine information about the source application 12 that is to be migrated. In implementation, an operator of the source computing environment 10 can initiate a process of the application migration system 100, which may include the discovery component 110 scanning resources of the source computing environment 10 in order to determine the applications that exist on the source computing environment. In some examples, the discovery component 110 can implement processes to automate (or substantially automate) discovery and characterization of the source application 12. The discovery component 110 can further implement a process in which application components of the source computing environment 10 can be determined.

The discovery component 110 can utilize an application library 119 to determine information about applications which are most suited for migration in general, or more specifically, applications which are best candidates for implementation on the target system 20. The application library 119 can also include information that reflects analysis of, for example, the source application 12 that is selected for migration. In some variations, the application library 119 can identify, for example, whether the source application 12 includes characteristics (termed ‘impacts’) that are likely to add complexity to the migration process.

According to some examples, the discovery component 110 determines a current model 123 (sometimes referred to as an “as-is model”) that provides a characterization of the source application 12 and/or the deployment of the source application 12 in the source computing environment 10. In one implementation, the application library 119 can include alternative variations of models for applications which have previously been selected or considered for migration. In variations, the discovery component 110 can include programming logic to generate or assimilate the current model 123 from discovered attributes of the source application 12.

In an example of FIG. 1, the target model determination component 120 applies a set of inference rules 122 to the current model 123 in order to determine a target model 125 for the application functionality 112 that is to be provided on the target system 20. The inference rules can thus provide a traceable mapping of attributes and characteristics of the source application 12 to that of the desired application functionality 112 in the target system 20.

According to some examples, the discovery component 110 can also implement processes to discover source policies 15 that are in use for the source application 12. The source policies 15 can be identified and transformed for use (when compatible or relevant) with the application functionality 112 that is to be provided on the target system 20. The discovery component 110 can augment or configure the current model 123 with known source policies 15 affecting the source application 12, and/or communicate the source policies 15 to template generator 130 and/or deployment component 140.

In addition to policy discovery and transformation, examples recognize that migration can require identification of constraints which may have not been relevant previously, but are relevant in the deployment and use of application functionality 112 in the target system 20. Additionally, examples recognize that an administrator or operator may want to use a migration event to change or configure policies. The application migration system 100 can include an administrator interface 118 (shown in an example of FIG. 1 with the discovery component 110) for enabling such administrator input. Collectively, the source policies 15, the constraints, and the administrator input can be parsed, de-duplicated and/or combined into a set of target policies 115.

The template generator 130 can operate to generate a template, or set of multiple templates 135, for specifying implementation of transformations based at least in part on the target model 125 and the target policies 115. Accordingly, the individual templates of the set of templates 135 can include computer-executable instructions, such as in the form of declarative machine-interpretable statements that can be assimilated as a deployment plan 145 for use by deployment component 140. The deployment component 140 uses the deployment plan 145, in connection with the application or program library 119, in order to perform transformations that establish the application functionality 112 as the migration of the source application 12. The templates 135 generated from the template generator 130 can, when executed as part of the deployment plan 145, implement a deployment objective or aspect thereof.

According to some examples, the target model determination component 120, template generator 130, and deployment component 140 combine to automate creation and implementation of the deployment plan 145 for guiding implementation of the application functionality 112 on the target system 20 as the migration of the source application 12. As described with various examples, the deployment plan 145 can represent a collective output of the template generator 130, which the deployment component 140 can utilize in order to perform the transformation and migration operations for implementing the application functionality 112 with the target system 20. The deployment plan 145 can include logic that can be triggered by migration (e.g., through execution by the deployment component 140) to recursively select and/or implement multiple deployment objectives 147 of varying levels of abstraction, defined through instructions of the deployment plan 145. The set of templates 135, for example, can include multiple templates that are nested and/or elective based on an output of another template. In this way, each of the deployment objectives 147 can be implemented as a script or executable instruction set of a corresponding template or set of templates. When migration is initiated, the deployment component 140 uses the deployment plan 145 to interface and configure select resources of the target system 20 in a manner that is set by the deployment objective, which in some cases, is unknown or of unknown value until migration (e.g., transformation operations) takes place.

In some examples, a primary or top-level deployment objective (or set of multiple deployment objectives) corresponds to a container selection for the application functionality 112. At least one template 137 can trigger the target system 20 to allocate a selected container, while initiating follow on migration operations that are specific to the selected container. One of the templates 135 can thus specify container selection (e.g., container type) and further include instructions to provision the target system 20 for the container selection. The selection of the container type can be made from a set of available containers which are available on the target system 20. For example, cloud-based computing environments can offer numerous types of containers from which selection can be made. The container types may be specific to, for example, a desired operational environment of the application functionality 112, such as a data environment or developer environment. As an alternative or variation, the container type can also specify whether the application functionality 112 is to be provided on a node, distributed amongst nodes or provided in a node cluster. As other alternatives or variations, the container type can specify whether virtual or physical servers are to define the containers, and/or a geographic region where physical servers that provide the container are to be located.

In other examples, the application functionality 112 can be implemented in alternative modes, such as developer mode and client mode. In such cases, separate containers and/or other deployment objectives can be utilized for each instance of the application functionality 112.

Similarly, individual components or aspects of the application functionality 112 can be separated into alternative containers. For example, the source application 12 can correspond to a multi-tiered application, which when transformed, can exist as multiple components (e.g., component for each tier), with each component including a different container.

The template generator 130 can utilize the target policies 115 in determining deployment objectives which configure or guide the deployment of the application functionality 112 in the target system 20. As an example, the target policies 115 can specify geographic restrictions or policies, such as provenance restrictions, which include prohibitions against data leaving or being stored outside of the country. The template generator 130 can generate the templates 135 which can be implemented to provide a deployment objective in which data of the application functionality can only reside within certain allowable parameters which define permissible geographic regions. The deployment objective can thus (i) provide for deployment of the application functionality 112 onto a specific data center or data centers within a geographic region, and/or (ii) designate workloads for colocation within a same data center, or on the same physical server or virtual machine. Still further, the deployment plan 145 can provide for deployment objectives which are designed to utilize containers and operational environments which are in compliance with a specific standard or requirement.

According to some examples, the deployment plan 145 can further provide for a deployment objective that is defined at least in part by one template 135 for automating the creation of a network architecture for the application functionality 112, or a component thereof. For example, the source application 12 can reside within a VLAN-centric environment, while the target model 125 can specify that the corresponding application functionality 112 is to execute in a VxLAN networked environment that is typical with OpenStack managed environments. In such an example, one of the templates 135 can specify instructions and parameters which, when implemented as part of the deployment plan 145, result in a deployment objective that creates the network topology for implementing the VxLAN networked environment.

Accordingly, examples provide that the templates 135 are selectively executable as part of the deployment plan 145. When the deployment plan 145 is executed by the deployment component 140, at least some predetermined deployment objectives are initiated automatically (e.g., container selection and configuration, network architecture creation), while other deployment objectives are determined from logic that utilizes an output of the implemented deployment objectives. In this way, some deployment objectives 147 of the deployment plan 145 can be selected and/or configured at runtime, based on outcomes of other implemented deployment objectives. The specific format, structure and organization of the set of templates 135 can vary in the manner in which deployment objectives 147 are defined and implemented. In some examples, the templates 135 collectively specify some deployment objectives 147 and provide logic for selecting or configuring other deployment objectives 147 when migration takes place.

In this manner, the set of templates 135 enable for selection of some deployment objectives to be just-in-time. Still further, in some variations, the deployment plan 145 includes templates which are not utilized when the deployment plan 145 is executed. As a result, the deployment plan 145 can enable a flexible deployment for the application functionality 112. Among other benefits, certain deployment decisions can be made just-in-time so as to not unnecessarily bind steps required from the migration with predetermined or irrelevant determinations.

According to some examples, the deployment objectives 145, which collectively can be implemented on the target system 20 through the deployment plan 145, are defined by individual templates 135 generated automatically by the template generator 130. In determining the templates 135 for migration of the source application 12, for example, the template generator 130 can use the target model 125 and the target policies 115. Likewise, logic for selecting some deployment objectives after migration is initiated can be implemented through logic that also links select sets of templates 135. In one implementation, the template generator 130 automates creation of a nested set of templates 135 that selectively determine and implement deployment objectives on an as-needed basis, while the migration is taking place. Thus, some deployment objectives can be identified and/or implemented through very late binding (e.g., after migration initiates, after provisioning, etc.). This allows for select features of the application functionality 112, such as user chosen options and other attributes or configurations, to be determined and implemented at an optimal time, rather than at a predetermined time. An optimal time, in the context provided, reflects a determination or configuration as taking place when such determination or configuration is needed. In this way, the execution of the deployment plan 145 is flexible, thus enabling automation based on the target policies 115 as well as an environment provided by the target system 20.

FIG. 1 illustrates the deployment plan 145 to include a series of deployment objectives 147, with recursive logic 149 to progressively determine and/or implement at least one of the deployment objectives. Each deployment objective 147 can be defined by one of the templates 135 generated by the template generator 130, based on the target model 125 and the target policies 115. By way of example, a top level deployment objective 147A can be implemented using a predetermined template. When deployed, the deployment objective 147A provisions a container from the target system 20. Once the migration is initiated, a next level deployment objective 147B can be specified through a corresponding template 135 generated from the template generator 130. The deployment objective 147B can be implemented to enforce suitable network patterns or archetypes (e.g. VLAN or VxLAN). A next level deployment objective 147C can specificity a server level characteristic (e.g., RAM, CPU, etc.). Another level deployment objective 147D can select specific application products or middleware and databases for the runtime (e.g. JBoss, Jetty, Oracle, PostgreSQL, etc.). Another level 147E of the deployment objective can specify OS characteristics (e.g. RHEL, Suse, Windows, etc.).

The recursive logic 149 can link the selection or implementation of one deployment objective 147 to an outcome of another deployment objective. For example, the deployment objective 147E for the operating system can be determined based on a prior outcome or determination, such as the selected application products or middleware of the deployment objective 147D.

As another example, the source application 12 can be multi-tiered and operating on a single node in the source computing environment. When migrated to the target system 20, the same application (or equivalent application functionality) can be separated, with each tier being designated to a different node. Such a transformation is network related (VLAN to VxLAN), and can be implemented through changes or configurations of network architecture, which can be specified through a corresponding template 135. The templates 135 generated through the template generator 130 can specify multiple deployment objectives to account for the separation of tiers to different nodes, with the selection of the specific deployment objective being made once the top-level deployment objective for the container is initiated on the target system 20.

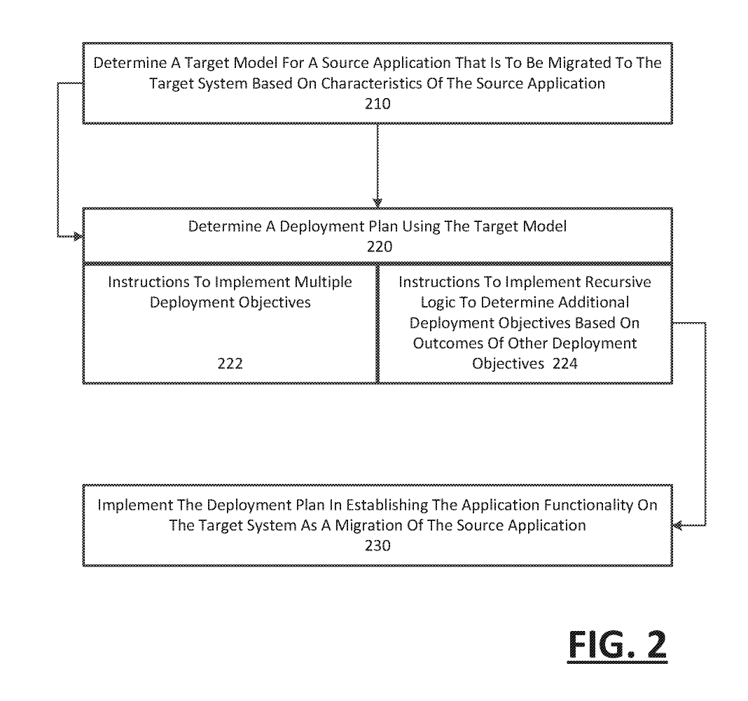

FIG. 2 illustrates an example method for migrating applications. An example of FIG. 2 can be implemented using, for example, a system such as described with an example of FIG. 1. Accordingly, reference may be made to elements of FIG. 1 for purpose of illustrating suitable components for implementing a step or substep being described.

With reference to an example of FIG. 2, application migration system 100 operates to determine a target model for a source application that is to be migrated to the target system (210). The determination can be based on a variety of factors, including source policies 15 and application characteristics of the source application (212).

The application migration system 100 can further operate to determine a deployment plan 145 using the target model (220). The deployment plan 145 can include executable instructions to implement multiple deployment objectives 147 for the application functionality with the target system 20 (222). Additionally, the deployment plan can include executable instructions to implement recursive logic, from which at least one additional deployment objective 147B . . . 147E can be determined based on an outcome of implementing another deployment objective 147A . . . 147D of the deployment plan 145 (224). The executable instructions in the deployment plan 145 can include a set of templates 135, some of which could be nested as appropriate to reflect a layered deployment architecture (e.g., application/platform/network/etc. layers) of the target system 20.

The application migration system 100 can further implement the deployment plan 145 in order to establish the application functionality 112 on the target system 20 as a migration of the source application 12 on the source computing environment 10 (230).

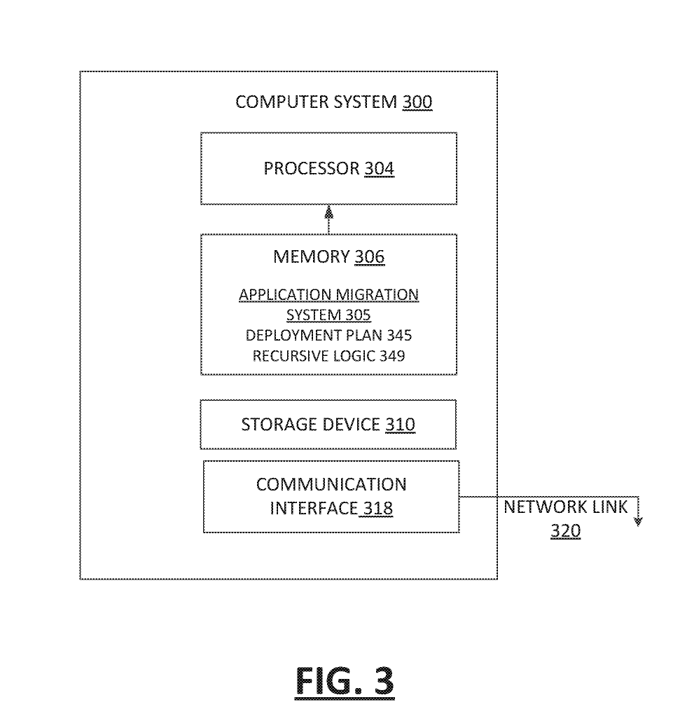

FIG. 3 illustrates an example computer system for implementing one or more examples. In particular, an example computer 300 can be used to implement an application migration system 100 such as described with an example of FIG. 1, or an example method such as described with FIG. 2. The computer system 300 includes at least one processor 304 for processing instructions. Computer system 300 also includes a memory 306, such as a random access memory (RAM) or other dynamic storage device, for storing information and instructions to be executed by processor 304. The memory 306 can include a persistent storage device, such as a magnetic disk or optical disk. The memory 306 can also include read-only-memory (ROM). A communication interface 318 enables the computer system 300 to communicate with other computers or data processing components, including individual wireless devices using, for example, a wireless GSM network or Public Switch Telephony Network (PSTN). As an alternative or addition, the communication interface 318 enables the computer system 300 to communicate with other services, such as administrative services or with servers of other service providers.

In an example of FIG. 3, the processor 304 executes one or more sequences of instructions stored in memory 306. Such instructions may be read into memory 306 from another machine-readable medium, such as a storage device. Execution of the sequences of instructions contained in memory 306 causes the processor 304 to perform operations such as described with an example application migration system 100 of FIG. 1 or an example method of FIG. 2.

With reference to an example of FIG. 3, the memory 306 can store instructions for implementing application migration system (“AMS instructions 305”), including deployment plan 345 having deployment objectives and recursive logic 349. The memory 306 can communicate the AMS instructions 305 to the processor 304, which can then execute to automate at least substantive portions of an application migration process, as described with examples of FIG. 1 and FIG. 2.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for migrating applications, the method being implemented by one or more processors and comprising:
determining a target model for a source application that is to be migrated to the target system, based at least in part on a set of policies and application characteristics of the source application;
determining a deployment plan using the target model, the deployment plan including executable instructions to implement (i) multiple deployment objectives for the application functionality with the target system, and (ii) recursive logic to determine at least one additional deployment objective based on an outcome of implementing another deployment objective of the deployment plan; and
implementing the deployment plan to establish the application functionality on the target system as a migration of the source application.

2. The method of claim 1, wherein determining the deployment plan includes generating multiple templates, each of the multiple templates including instructions for implementing at least one of the multiple deployment objectives.

3. The method of claim 2, wherein generating multiple templates includes generating a set of templates that are nested, so that instructions of at least a first template of the set of templates includes a dependency to at least a second template of the set.

4. The method of claim 1, wherein implementing the deployment plan includes determining at least a first deployment objective based at least in part on the target model, and wherein the method further comprises determining, after the migration is initiated but before migration is complete, at least a second deployment objective based at least in part on an outcome of implementing the at least first deployment objective.

5. The method of claim 1, wherein determining the target model is based at least in part on a set of characteristics of the target system.

6. The method of claim 1, wherein determining the target model is based at least in part on a set of target policies, the set of target policies being based at least in part on a set of source policies.

7. The method of claim 6, wherein the set of target policies include at least one geographic or spatial restriction as to a location of a component of the application functionality.

8. The method of claim 1, wherein determining the target model includes selecting an attribute or characteristic for the application functionality that is to be provided with the target system so that the application functionality is in compliance with a service level agreement of the source application.

9. The method of claim 1, wherein determining the target model is based at least in part on a current model of an application in the source computing environment.

10. The method of claim 9, wherein determining the target model includes applying a set of inference rules to the current model of the source application.

11. The method of claim 1, wherein the target system is a cloud-based computing environment.

12. The method of claim 1, wherein determining the deployment plan includes implementing recursive logic by nesting a set of deployment objectives of the deployment plan.

13. The method of claim 1, wherein each deployment objective of the set is defined by instructions that are generated based in part on the target model, the deployment objectives including at least (i) a top level deployment objective for provisioning a container of the target system for the application functionality, (ii) a set of next level deployment objectives for determining a network topology for the application functionality when provided in the container of the target system, and (iii) a set of second next level deployment objective for determining a set of runtime resources for implementing the application functionality with the network topology and the container of the target system.

14. A non-transitory computer-readable medium that stores instructions, which when executed by one or more processors of a computer system, cause the computer system to:
determine a target model for a source application that is to be migrated to the target system, based at least in part on a set of application characteristics of the source application;
determine a deployment plan using the target model, the deployment plan including executable instructions to implement (i) multiple deployment objectives for the application functionality with the target system, and (ii) recursive logic to determine at least one additional deployment objective based on an outcome of implementing another deployment objective of the deployment plan; and
determine the deployment plan to establish the application functionality on the target system as a migration of the source application.

15. A computer system comprising:
a memory that stores a set of instructions;
one or more processors that access the set of instructions to:
determine a target model for a source application that is to be migrated to the target system, based at least in part on a set of application characteristics of the source application;
determine a deployment plan using the target model, the deployment plan including executable instructions to implement (i) multiple deployment objectives for the application functionality with the target system, and (ii) recursive logic to determine at least one additional deployment objective based on an outcome of implementing another deployment objective of the deployment plan; and
implement the deployment plan to establish the application functionality on the target system as a migration of the source application.
